(19) United States
(12) Patent Application Publication
(10) Pub. No.: US 2026/0177437 A1
(43) Pub. Date: Jun. 25, 2026

(54) PEDAL MOTION SIGNAL DETECTION DEVICE

(71) Applicant: BION INC., New Taipei City (TW)

(72) Inventor: YU-YU CHEN, New Taipei City (TW)

(21) Appl. No.: 19/414,296

(22) Filed: Dec. 10, 2025

(30) Foreign Application Priority Data
Dec. 20, 2024 (TW) 113149787

(51) Int. Cl. G01L 5/00; A63B 22/06; A63B 24/00

(52) U.S. Cl. CPC G01L 5/0042; A63B 22/0605; A63B 24/0062; A63B 2022/0611; A63B 2220/24; A63B 2220/56; A63B 2220/803; A63B 2225/20

(57) ABSTRACT

A pedal motion signal detection device includes a stator sleeve shaft and an inner sleeve shaft. The stator sleeve shaft passes through a bearing in a shaft hole of a pedal spindle, and a positioning groove is provided inside the stator sleeve shaft. One end of the stator sleeve shaft has a through hole communicating with the positioning sleeve shaft. The inner sleeve shaft passes through the through hole and inserted in the positioning groove and is fixed to the stator sleeve shaft by threading or tight fitting. At least one pressure sensing unit is provided on the outer peripheral surface of the inner sleeve shaft to measure the force intensity of stepping on the pedal and the force distribution on the surface of the exercise bike pedal.

### BACKGROUND OF THE INVENTION

### 1. Fields of the Invention

The present invention relates to the field of exercise and fitness equipment, and particularly, to a pedal motion signal detection device.

### 2. Descriptions of Related Art

Modern people seek to address the numerous health problems caused by excessive dietary intake and overnutrition, such as obesity, by adjusting their physiological functions through appropriate exercise to meet health needs. Among various exercise methods, cycling can not only improve cardiopulmonary function, but also has excellent effects on exercising the back muscles, buttocks and lower limbs, making it quite popular and well-received among exercise enthusiasts.

However, riding a bicycle requires continuous pedaling to achieve exercise effects. Over time, this can easily cause sports injuries to the rider and cannot improve riding efficiency. Therefore, various sensing devices have been developed that can record the rider's exercise status each time or detect the exercise force signals generated by the left and right feet during exercise, providing reference information for the rider during exercise, thereby allowing the rider to adjust exercise habits during the exercise process and improve riding efficiency.

For example, U.S. Patent No. U.S. Pat. No. 8,011,242B2 discloses a prior art patent case in which four sensing elements are respectively arranged on both sides of the pedal spindle stator to detect and analyze the force intensity applied by the rider on the exercise bike pedal, as well as the force distribution on the surface of the exercise bike pedal. This enables the rider to obtain continuous related data throughout the rotation cycle to improve pedal efficiency and achieve better exercise effects on the exercise bike. However, because the motion signals detected by the sensing elements in this prior art patent case must be transmitted through wiring and then connected to the other end through a connector, the overall structure is complex, and the wiring extends from one side where the pedal connects to the exercise bike, causing the wire to be exposed, which can easily create danger.

In addition, in this prior art patent case, four sensors (top, bottom, left, right) are placed on both sides of the stator. Therefore, when the rider steps on the pedal, the pedal rotor may not necessarily step on the sensor, but may also step on the position between sensors. In this case, the pedaling force detected by the sensor is incorrect, resulting in detection that is not the actual pedaling force, thus causing accuracy problems.

Additionally, another prior art patent case, U.S. Patent No. U.S. Pat. No. 10,551,260B2, discloses a sleeve connected to the stator, with the sleeve being integrated with the pedal to form a single unit. During exercise, sensors placed on both sides of the sleeve can form an integrated unit with the pedal, so that the pedaling force acts directly from the stator spindle to the sensors on the sleeve. One end of the stator spindle is combined with a bearing at one end of the sleeve, while the sleeve is threadedly combined with the rotor, and the sensors are fixed on both sides of the sleeve. However, because the sleeve body is bulky and combined with the power battery and signal control board, the structure is complex, making maintenance and replacement difficult.

Furthermore, for example, in the prior art patent case U.S. Patent No. U.S. Pat. No. 11,919,596B2, strain force sensing elements are fixedly attached around the inner sidewall of the chamber inside the stator spindle to detect and analyze the force intensity applied by the rider on the exercise pedal and the force distribution on the pedal surface.

However, because this prior art patent case attaches the strain force sensing elements to the inner sidewall surface of the chamber inside the stator spindle, the positive and negative directional calculation logic of the signals measured by the sensing elements is reversed and highly complex. Moreover, because the sensing elements are attached to the inner sidewall surface of the chamber inside the stator spindle, the sensing elements are prone to falling off and difficult to reattach, making it difficult to implement either during pre-shipment assembly or subsequent maintenance.

Alternatively, prior art patent cases such as U.S. Pat. Nos. U.S. Pat. No. 8,011,242 B2 and U.S. Pat. No. 8,961,191 B2 both have an independent strain force sensing device built deep within the chamber inside the stator spindle. This is used to measure and analyze the force intensity applied by the rider on the exercise bike pedal and the force distribution on the pedal surface. However, the independent strain force sensing device is a component completely independent of the spindle stator and is a solid rather than hollow metal component. Therefore, it must be tightly fitted in the center position of the inner layer chamber of the stator spindle. Furthermore, because it is designed as a strain sensing device completely independent within the spindle, it uses an indirect signal sensing method during sensing and measurement, with weak force signal detection, complex design, difficult assembly, and very difficult maintenance or after-sales service.

In summary, existing pedal signal detection devices still have their problems and are therefore not a good design.

The present invention intends to provide a pedal motion signal detection device to eliminate the shortcomings mentioned above.

### SUMMARY OF THE INVENTION

To overcome the problems described in the prior art, the object of the present invention is to provide a pedal motion signal detection device with a simple structure that is easy to produce and assemble.

To achieve the aforementioned object, the pedal motion signal detection device provided by the present invention includes a pedal, a stator sleeve shaft, and an inner sleeve shaft. A shaft hole is provided at the spindle position of the pedal, and a bearing is provided in the shaft hole. The stator sleeve shaft passes through the shaft hole. A positioning groove coaxial with the stator sleeve shaft is provided inside the stator sleeve shaft, and one end of the stator sleeve shaft has a through hole communicating with the positioning groove. The inner sleeve shaft passes through the through hole and inserted in the stator sleeve shaft, and at least one pressure sensing unit is provided on the outer peripheral tube wall of the inner sleeve shaft. The inner sleeve shaft is fixed in the positioning groove by tight fitting or screw fastening.

The device further includes a control circuit provided at one end of the stator sleeve shaft and connected to the pressure sensing unit. The control circuit includes at least a signal reading unit, a signal processing unit, a trajectory sensing unit, a trajectory sensing circuit, a pressure sensing circuit, and a wireless transmission module device. The pressure sensing circuit reads the force status of the rider on the pedal detected by the pressure sensing unit through the signal reading unit, and obtains motion signals of spatial angle change positions from the trajectory sensing unit, the trajectory sensing circuit, and the pedal. Then the signal processing unit processes them to obtain the force value of the rider, and transmits the force value of the rider through the wireless transmission module device to a display screen to provide the rider with reference information during exercise.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective external view of the pedal motion signal detection device of the present invention;

FIG. 2 is an exploded view from another viewing angle of the pedal motion signal detection device of the present invention;

FIG. 3A is an exploded view of the stator sleeve shaft and inner sleeve shaft in the pedal motion signal detection device of the present invention;

FIG. 3B is an exploded view of another embodiment of the stator sleeve shaft and inner sleeve shaft in the pedal motion signal detection device of the present invention;

FIG. 4 is a side cross-sectional exploded view of the stator sleeve shaft and inner sleeve shaft in the pedal motion signal detection device of the present invention;

FIG. 5 is a schematic diagram of the architecture of the control circuit in the pedal motion signal detection device of the present invention;

FIGS. 6 to 9 are schematic diagrams showing the force state and force angle of a bicycle pedal and changes in tensile stress and compressive stress;

FIG. 10 is a perspective schematic diagram of another embodiment of the present invention, and

FIG. 11 is a cross-sectional schematic diagram, taken along line XI-XI of FIG. 10.

### DETAILED DESCRIPTION OF THE PREFERRED EMBODIMENT

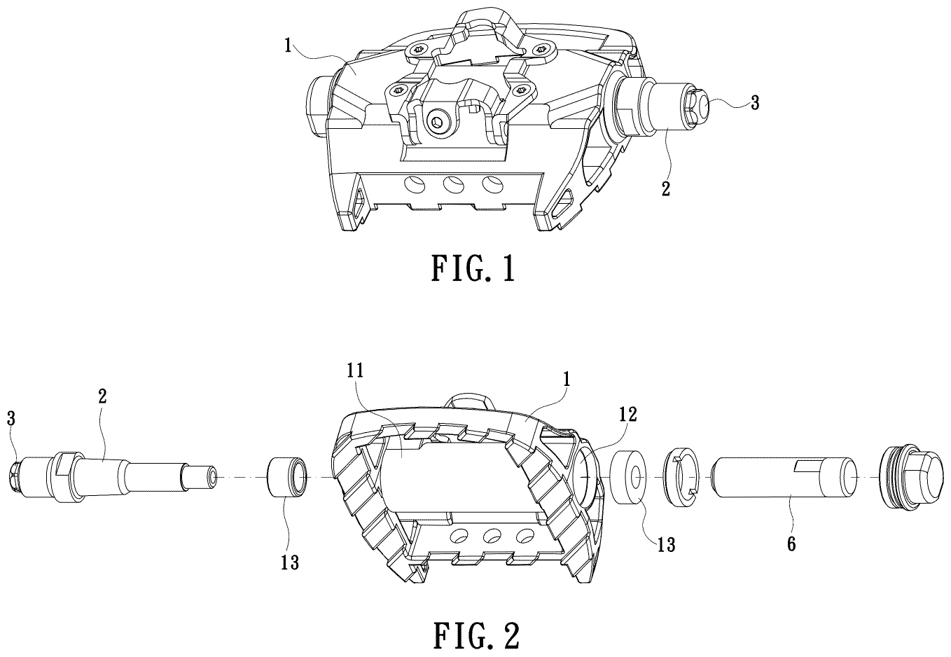

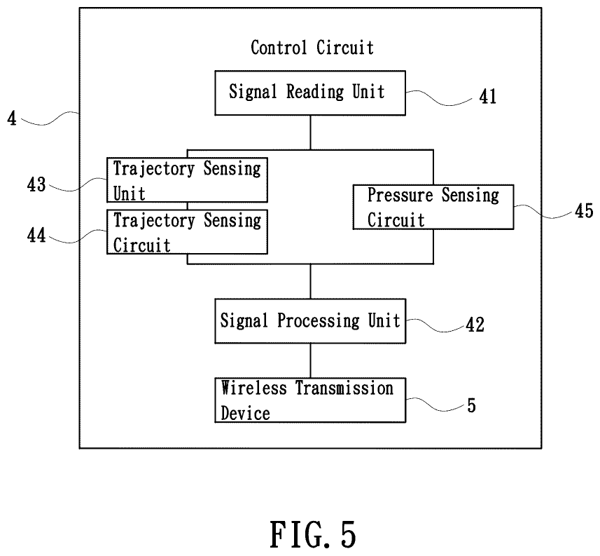

Referring to FIGS. 1 to 5, the pedal motion signal detection device of the present invention comprises a pedal 1, a stator sleeve shaft 2, an inner sleeve shaft 3, and a control circuit 4. The pedal 1 can be provided with clip-in system clips on both the front and back surfaces. The clips can be arranged such that both the front and back surfaces of the pedal use SPD clips or both use LOOK clips, or the front and back surfaces of the pedal 1 are respectively arranged with one side having SPD clips and the other side having LOOK clips. Additionally, the spindle 11 of the pedal 1 is provided with a shaft hole 12 that is defined through the spindle, and bearings 13 are respectively provided in the shaft hole 12 at positions near both opening ends of the shaft hole 12. The interior of the stator sleeve shaft 2 is provided with a positioning groove 21 coaxial with the stator sleeve shaft 2, and one end of the stator sleeve shaft 2 has a through hole 22 communicating with the positioning groove 21. An internal thread 23 is provided at any position on the inner peripheral wall surface of the positioning groove 21.

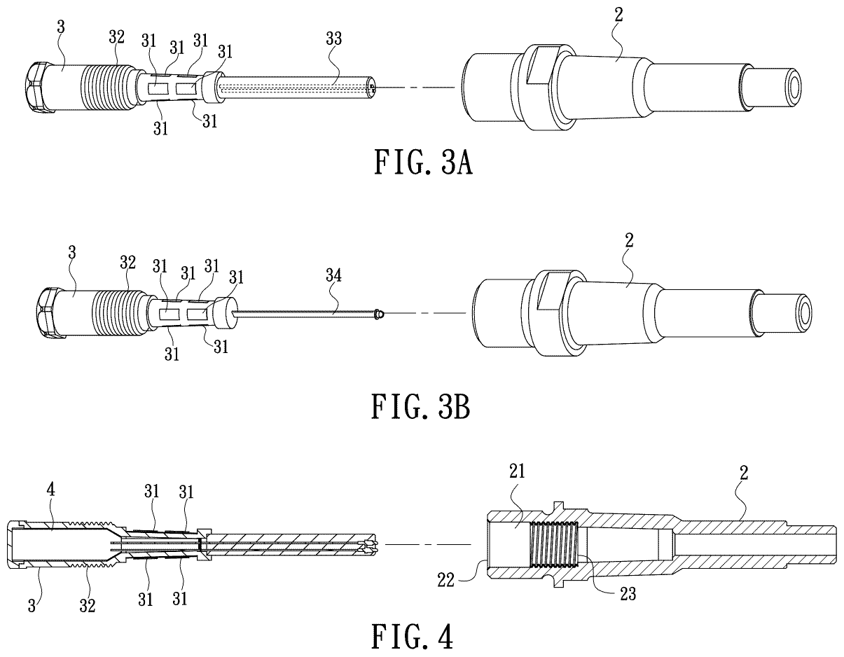

Pressure sensing units 31 are provided on the top, bottom, left, and right wall surfaces at coaxial positions of the outer peripheral tube wall of the inner sleeve shaft 3. An external thread 32 is provided on the outer peripheral wall of the inner sleeve shaft 3 at a position corresponding to the internal thread 23 on the inner peripheral wall surface of the positioning groove 21. Additionally, as shown in FIG. 3A, one end of the inner sleeve shaft 3 is provided with a wire conduit 33 (or as shown in FIG. 3B, one end of the inner sleeve shaft 3 is provided with a circuit board 34). The control circuit 4 includes at least a signal reading unit 41, a signal processing unit 42, a trajectory sensing unit 43, a trajectory sensing circuit 44, and a pressure sensing circuit 45. The signal reading unit 41 is respectively connected to the trajectory sensing unit 43 and the pressure sensing circuit 45. The trajectory sensing unit 43 is connected to the trajectory sensing circuit 44. The trajectory sensing circuit 44 and the pressure sensing circuit 45 are further connected to the signal processing unit 42. Additionally, the control circuit 4 is provided at one end of the stator sleeve shaft 2 and forms an integrated structure with a wireless transmission device 5. Furthermore, the pedal motion signal detection device provided by the present invention further includes a power supply device 6 that provides electrical power for use by the control circuit 4 and the pressure sensing unit 31.

When assembling the pedal motion signal detection device of the present invention, the inner sleeve shaft 3 is inserted through the through hole 22 into the positioning groove 21 of the stator sleeve shaft 2, and the external thread 32 provided on the outer periphery of the inner sleeve shaft 3 is screwed together with the internal thread 23 on the inner peripheral wall surface of the positioning groove 21 (or the internal thread 23 and external thread 32 may not be provided, and a tight fitting method may be used instead) to fix the inner sleeve shaft 3 in the positioning groove of the stator sleeve shaft 2. Then the stator sleeve shaft 2 is inserted into the shaft hole 12 of the pedal 1, with both ends of the stator sleeve shaft 2 respectively pivotally mounted on the bearings 13 respectively provided at both opening ends of the shaft hole 12. The pedal motion signal detection device of the present invention uses four pressure sensing units 31 provided on the outer peripheral wall of the inner sleeve shaft 3 to detect position changes generated by the pedal 1 when stepping on the pedal 1, as well as motion signals of the force status of the pedal 1, to obtain motion signals of the spatial angle position of the pedal 1. At this time, the pressure sensing circuit 45 reads the force status of stepping on the pedal 1 detected by the pressure sensing unit 31 through the signal reading unit 41, and then obtains motion signals of spatial angle change positions from the trajectory sensing unit 43 and trajectory sensing circuit 44 of the control circuit board 4 and the pedal 1. Then the signal processing unit 42 processes them to obtain the force value of stepping on the pedal 1, and transmits the force value of stepping on the pedal 1 through the wireless transmission device 5 to a display (not shown in the figure) for display.

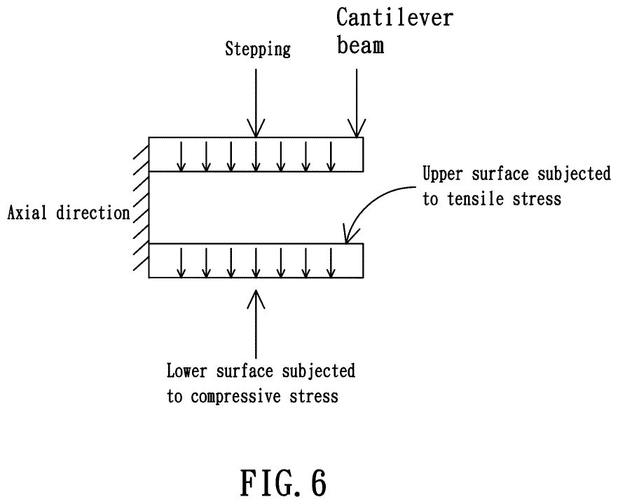

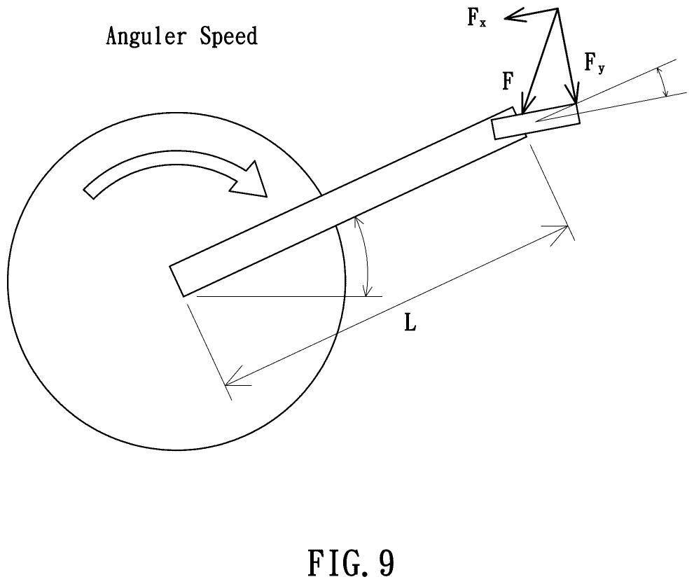

Referring to FIGS. 6 to 9, when the pedal motion signal detection device of the present invention detects position changes generated by the pedal 1 when stepping on the pedal 1, as well as motion signals of the force status of the pedal 1, to obtain motion signals of the spatial angle position of the pedal 1, cantilever theory can demonstrate the upper surface tensile stress and lower surface compressive stress conditions detected by the pressure sensing unit 31 on the upper periphery of the inner sleeve shaft 3 when the rider applies force at various angles of 360 degrees on the pedal 1 at angles 90 degrees→0 degrees→270 degrees→180 degrees.

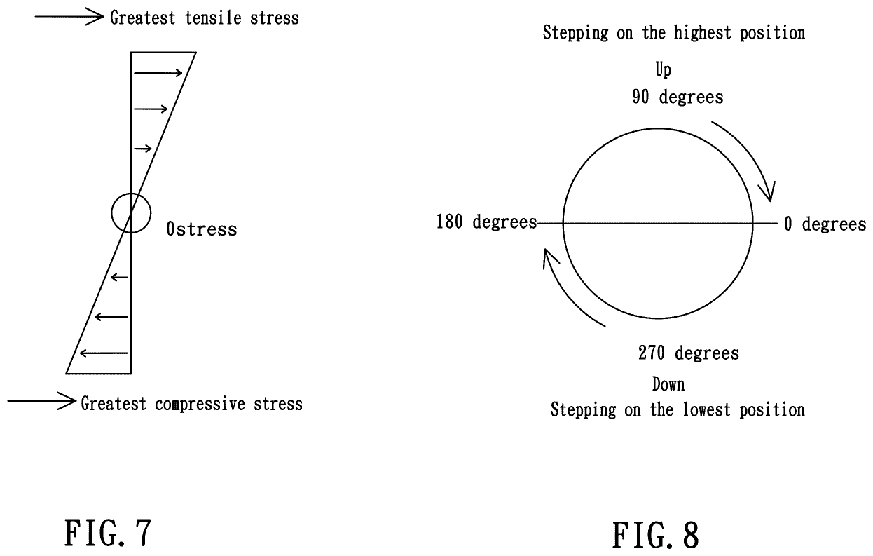

When stepping on the pedal 1 from above, when the pedal 1 is at 90 degrees as shown in FIG. 8, the tensile stress on the upper surface of the pedal 1 is greatest (as shown in the upper part of FIG. 7). When the pedal 1 is at 0 degrees as in FIG. 8, the stress is zero. When the pedal 1 is at 270 degrees as in FIG. 8, which is also when stepping on the lowest position of the pedal 1, the compressive stress it receives is greatest.

Additionally, when stepping on the pedal 1 from above, the pedal 1 is like a swing arm connected to the flywheel center. Therefore, with a swing arm length of L, under the action of pedaling force F, the generated torque is:

$$Toeque = F cos θ = Fy \times L$$

$$Work done : Power = Torque \times ω2$$

As described above, in the pedal motion signal detection device of the present invention, by inserting the inner sleeve shaft 3 into the positioning groove 21 of the stator sleeve shaft 4 to form a coaxial structure, and combining them through screwing together or tight fitting of the internal thread 23 and external thread 32, it is possible to measure the motion signals of the pedal 1 and the 360° motion trajectory with higher precision. At the same time, it can measure stable and beautiful signal waveforms, and the strain force can be completely consistent with the positive and negative logic of the pedaling force changes and direction of the pedal 1. Moreover, the overall structure is simple, easy to produce and assemble, and convenient for maintenance and replacement (using the principle of thermal expansion and contraction for replacement). Therefore, compared to the various prior art patent cases, the present invention has obvious novelty, inventiveness, and industrial applicability.

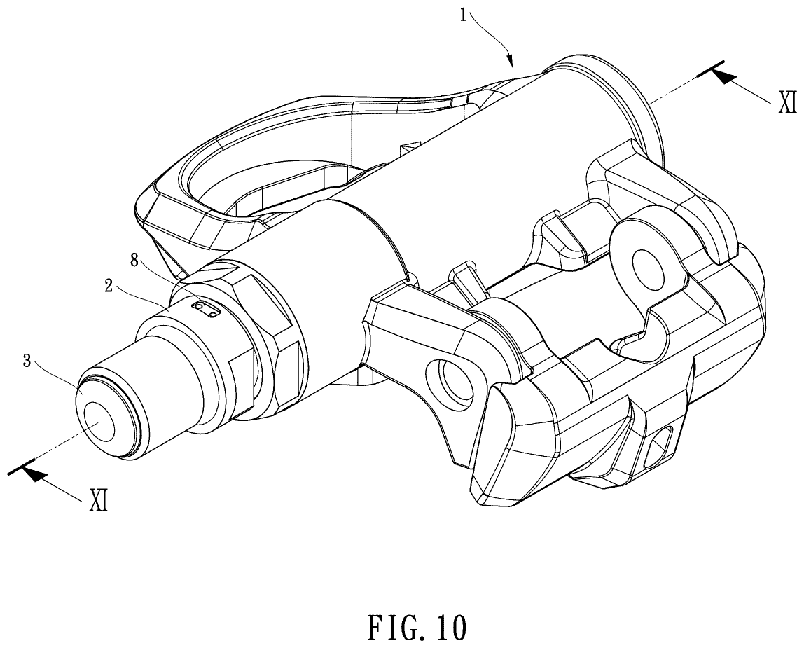

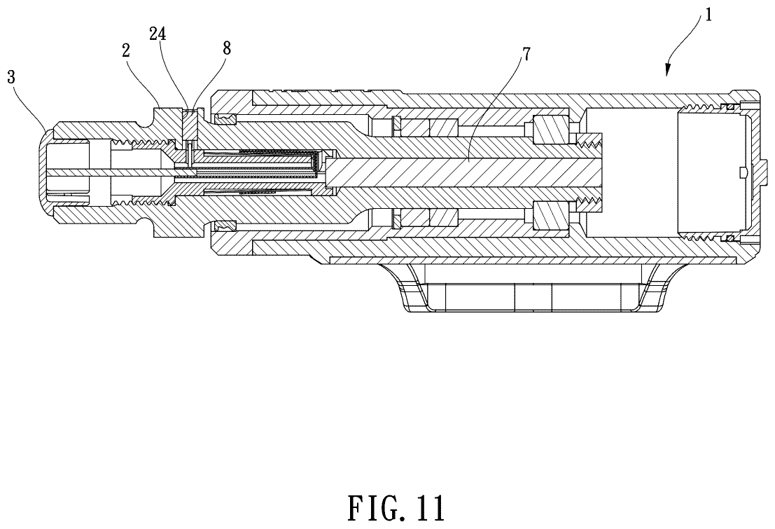

In addition, the present invention has another power supply embodiment, as shown in FIGS. 10 and 11, which includes a rechargeable battery 7 and a charging port 8. The rechargeable battery 7 is electrically connected to the pressure sensing unit 31, the control circuit 4, and the charging port 8. The rechargeable battery 7 provides electrical power for use by the pressure sensing unit 31 and the control circuit 4. The charging port 8 can charge the rechargeable battery 7 after connecting to charging equipment. As shown in the figure, the charging port 8 can be provided at an opening 24 of the stator sleeve shaft 2.

While we have shown and described the embodiment in accordance with the present invention, it should be clear to those skilled in the art that further embodiments may be made without departing from the scope of the present invention.

What is claimed is:

1. A pedal motion signal detection device, comprising:
a stator sleeve shaft, the stator sleeve shaft passing through a shaft hole provided at a spindle of a pedal, an interior of the stator sleeve shaft having a positioning groove coaxial with the stator sleeve shaft, one end of the stator sleeve shaft having a through hole communicating with the positioning groove;
an inner sleeve shaft, the inner sleeve shaft passing through the through hole and inserted in the stator sleeve shaft, and an outer peripheral wall of the inner sleeve shaft having at least one pressure sensing unit, and
a control circuit, the control circuit being provided on the inner sleeve shaft and connected to the pressure sensing unit.

2. The pedal motion signal detection device as claimed in claim 1, wherein the inner sleeve shaft is fixed in the positioning groove by tight fitting or screw fastening.

3. The pedal motion signal detection device as claimed in claim 1, wherein at least one bearing is provided in the shaft hole at a spindle of the pedal, and the stator sleeve shaft passes through the bearing such that the pedal rotates on the stator sleeve shaft using the bearing.

4. The pedal motion signal detection device as claimed in claim 1, wherein the control circuit is located at one end of the stator sleeve shaft and forms an integrated structure with a wireless transmission device.

5. The pedal motion signal detection device as claimed in claim 4, wherein the control circuit includes at least a signal reading unit, a signal processing unit, a trajectory sensing unit, a trajectory sensing circuit, and a pressure sensing circuit, the pressure sensing circuit reads a force status on the pedal detected by the pressure sensing unit through the signal reading unit, and obtains motion signals of spatial angle change positions from the trajectory sensing unit, the trajectory sensing circuit, and the pedal, the motion signals are processed by using the signal processing unit to obtain a force value, and the force value is transmitted through the wireless transmission device to a display screen.

6. The pedal motion signal detection device as claimed in claim 1, further comprising a power supply device, the power supply device providing electrical power to the pressure sensing unit and the control circuit.

7. The pedal motion signal detection device as claimed in claim 1, further comprising a rechargeable battery and a charging port, the rechargeable battery being electrically connected to the pressure sensing unit, the control circuit, and the charging port.
